(19) United States
(12) Patent Application Publication
(10) Pub. No.: US 2021/0361109 A1
(43) Pub. Date: Nov. 25, 2021

(54) STRAINER WITH CHANGEABLE VOLUME AND BEVERAGE CONTAINER HAVING THE STRAINER

(71) Applicant: Tzu Yuan Shen, Nantou County (TW)

(72) Inventor: Tzu Yuan Shen, Nantou County (TW)

(21) Appl. No.: 16/882,664

(22) Filed: May 25, 2020

(51) Int. Cl. A47J 31/06; A47G 19/16; B65D 43/02

(52) U.S. Cl. CPC A47J 31/0615; B65D 43/0225; A47G 19/16

(57) ABSTRACT

A beverage container having a strainer includes a body having an opening end with a coupling portion. The strainer includes a ring member connected with the coupling portion and a plurality of bridge portions connected with the ring member. A plurality of outlets is formed between the bridge portions and the ring member. A first bucket member with a first stopping portion is detachably connected with the connecting member. A second bucket member is movably connected with the first bucket member to move upwardly or downwardly along the first bucket member. A second stopping portion is disposed on the second bucket member for being blocked by the first stopping portion to prevent the second bucket member from leaving the first bucket member.

### BACKGROUND OF THE INVENTION

### 1. Technical Field

The present invention relates to a beverage container and more particularly to a beverage container having a strainer.

### 2. Description of Related Art

There are many cup or bottle products on the market. One of those, such as that disclosed in TW Utility Patent No. M495808, includes a strainer assembled on the opening of the bottle. Tea leaves are put in the strainer for separation from liquid when in brewing. However, position of the strainer in the bottle is fixed. When water level is low, the strainer cannot be submerged in the water to brew drinks.

Another bottle, as disclosed in TW Utility Patent No. M465867, includes a lid with a hole and a strainer tied with a string. The strainer is hanged in the bottle with the string passing through the hole. Accordingly, position of the strainer in the bottle can be changed by pulling the string. Moreover, a strainer disclosed in TW Utility Patent No. M465868 includes a plurality of hangers, each of the hangers being provided at different levels. Accordingly, position of the strainer in the bottle can be changed by the chosen hanger hanged on the bottle.

Although positions of both of the two strainers abovementioned can be changed, volumes in the two strainers are still fixed to contain a fixed amount of tea leaves. No more tea leaves can be contained to get stronger tea.

### BRIEF SUMMARY OF THE INVENTION

The primary objective of the present invention is to provide a beverage container having a strainer that is able to change volume and position level in the beverage container for determining the quantity of tea leaves and the brewing situation.

To achieve the above objective, the present invention provides a strainer with changeable volume including a ring member with a positioning portion provided on a periphery of the ring member for connection with a beverage container. A connecting member having a plurality of bridge portions is connected with the ring member. A plurality of outlets is formed between the bridge portions and the ring member. A first bucket member is connected with the connecting member. The first bucket member includes a first annular wall with a first opening and a first stopping portion. A second bucket member includes a second annular wall connected with a bottom wall. A top end of the second annular wall has a second opening communicated with the first opening and a second stopping portion. A plurality of side sieve holes is disposed on the second annular wall. The second annular wall is movably connected with the first annular wall so that the second bucket member is capable of moving upwardly or downwardly along the first bucket member. The second stopping portion is blocked by the first stopping portion to prevent the second bucket member from leaving the first bucket member.

In one embodiment, the second bucket member is provided inside the first bucket member. The first stopping portion is an inner flange formed on the first opening while the second stopping portion is an outer flange formed on the second opening.

Preferably, a top end of the first annular wall detachably connects with the bottom end of the connecting member by threads.

Preferably, the second annular wall is provided with a slip proof portion abutting against the first annular wall.

Preferably, the bottom wall of the second bucket member is provided with a plurality of bottom sieve holes.

In another embodiment, an interior and an exterior of the first bucket member are not in communication with each other through the first annular wall directly. The bottom end of the first annular wall is provided with a waterproof ring closely connected with the second annular wall.

Furthermore, the present invention provides a beverage container having the strainer abovementioned, including a body having a first opening end with a coupling portion. The strainer including a ring member with a positioning portion provided on a periphery of the ring member for connection with the coupling portion. A connecting member having a plurality of bridge portions is connected with the ring member. A plurality of outlets is formed between the bridge portions and the ring member. A first bucket member is connected with the connecting member. The first bucket member includes a first annular wall with a first opening and a first stopping portion. A second bucket member includes a second annular wall connected with a bottom wall. A top end of the second annular wall has a second opening communicated with the first opening and a second stopping portion. A plurality of side sieve holes is disposed on the second annular wall. The second annular wall is movably connected with the first annular wall so that the second bucket member is capable of moving upwardly or downwardly along the first bucket member. The second stopping portion is blocked by the first stopping portion to prevent the second bucket member from leaving the first bucket member.

Preferably, a second opening end with a detachable lid is disposed at an end of the body opposite to the first opening end.

### BRIEF DESCRIPTION OF THE SEVERAL VIEWS OF THE DRAWINGS

FIG. 1 is an exploded perspective view of a first embodiment of the strainer in the present invention;

FIG. 2 is a sectional view showing the strainer in FIG. 1;

FIG. 3 is an exploded perspective view of a first embodiment of the beverage container in the present invention;

FIG. 4 and FIG. 5 show how to use the beverage container in FIG. 3 to brew drinks;

FIG. 6 shows how the beverage container in FIG. 3 pours drinks out;

FIG. 7 is an exploded perspective view of a second embodiment of the strainer in the present invention;

FIG. 8 is a sectional view of the strainer in FIG. 7; and

FIG. 9 is a sectional view of a second embodiment of the beverage container in the present invention.

### DETAILED DESCRIPTION OF THE INVENTION

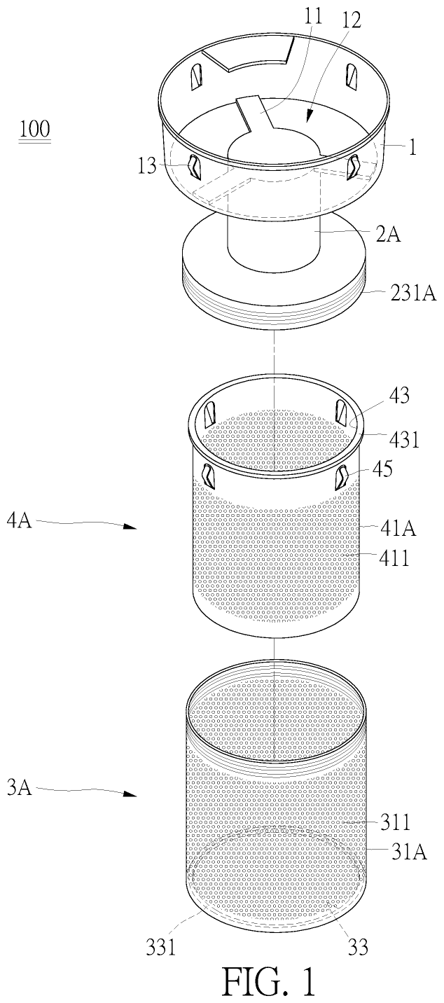

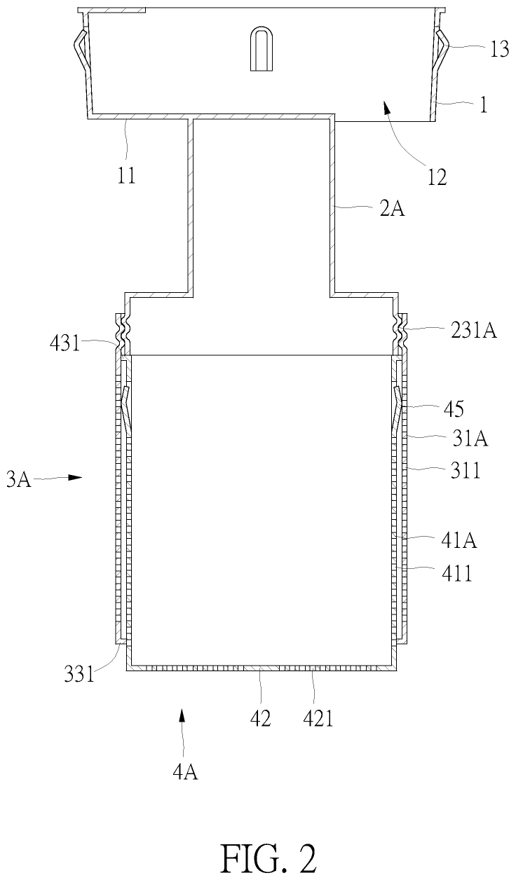

Referring to FIG. 1 and FIG. 2, the strainer 100 with changeable volume according to a first embodiment of the present invention includes a ring member 1, a connecting member 2A, a first bucket member 3A and a second bucket member 4A. The connecting member 2A has a columnar body with three bridge portions 11 disposed at a top end. Each of the three bridge portions 11 is connected with the ring member 1 and thus three outlets 12 are formed between the bridge portions 11 and the ring member 1. Four positioning portions 13 are provided on a periphery of the ring member 1 for connection with a beverage container. In this embodiment, each of the positioning portions 13 is a flake bent outwardly from the ring member 1.

A bottom end 231A of the connecting member 2A expands and engages with the first bucket member 3A by threads.

The first bucket member 3A has a first annular wall 31A provided with a plurality of side sieve holes 311 while the second bucket member 4A has a second annular wall 41A provided with a plurality of side sieve holes 411. A top end of the first annular wall 31A is connected with the bottom end 231A of the connecting member 2A. A bottom end of the first annular wall 31A has a first opening 33 with an inner flange 331. The second bucket member 4A has a second annular wall 41A connected with a bottom wall 42A having a plurality of bottom sieve holes 421. A top end of the second annular wall 41A has a second opening 43 with an outer flange 431.

The second bucket member 4A is provided inside the first bucket member 3A. The second opening 43 is in communication with the first opening 33. The second annular wall 41A is movably connected with the first annular wall 31A so that the second bucket member 4A is capable of moving upwardly or downwardly along the first bucket member 3A. Accordingly, volume of the strainer 100 can be changed.

When pulling down the second bucket member 4A, the outer flange 431 is blocked by the inner flange 331 so as to prevent the second bucket member 4A from leaving the first bucket member 3A.

In this embodiment, a plurality of slip proof portion 45 is provided on the second annular wall 41A. Each of the slip proof portion 45 is a flake bent outwardly from second annular wall 41A to abut against the first annular wall 31A, making the second bucket member 4A position on the first bucket member 3A.

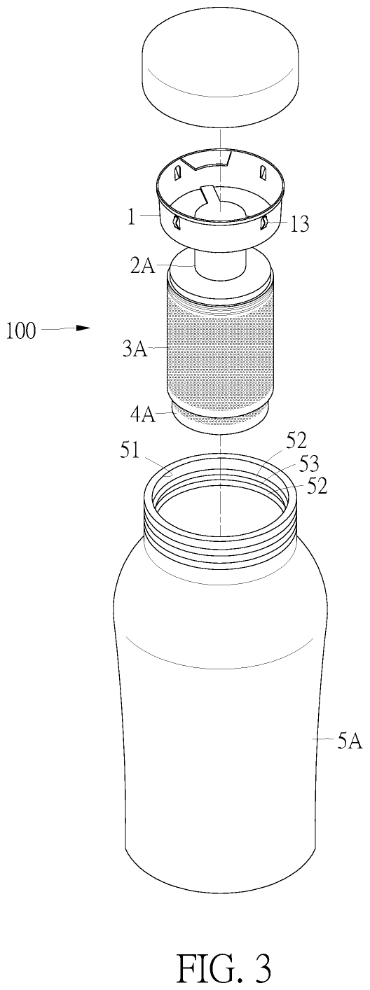

As shown in FIG. 3, a beverage container according to the present invention includes a body 5A formed as a cup or a bottle. The body 5A has a first opening end 51 with a coupling portion for connection with the strainer 100. The coupling portion includes two spaced annular flanges 52 with a groove 53 therebetween. The positioning portions 13 of the ring member 1 are inserted into the groove 53 so that the strainer 100 is positioned in the body 5A.

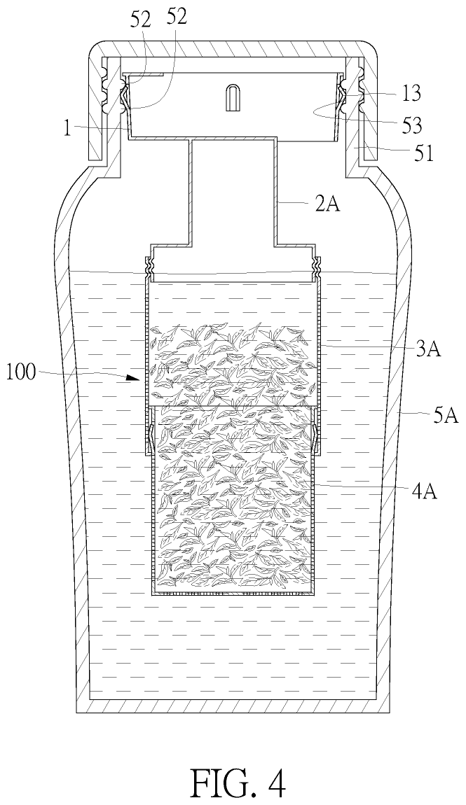

Tea leaves can be put in the strainer 100 for separation from liquid when in brewing. Since flavor of the tea depends upon the amount of tea leaves, volume of the strainer 100 is able to increase for more tea leaves through that the second bucket member 4A being pulled down relative to the first bucket member 3A, as shown in FIG. 4.

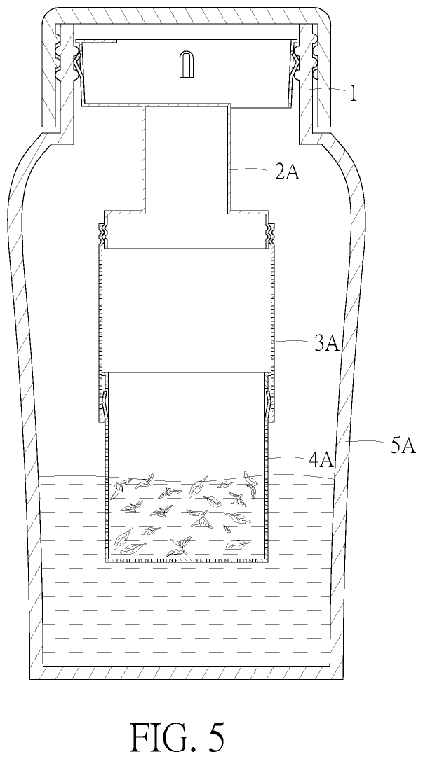

In addition, as shown in FIG. 5, the second bucket member 4A approaches the bottom of the body 5A since the second bucket member 4A is pulled down. Therefore, the strainer 100 and tea leaves can be submerged in the water for brewing even if the water level of the body 5A is low. On the other hand, the body 5A may be designed into a long deep shape. The strainer 100 and tea leaves still can be submerged in the water for brewing through pulling down the second bucket member 4A.

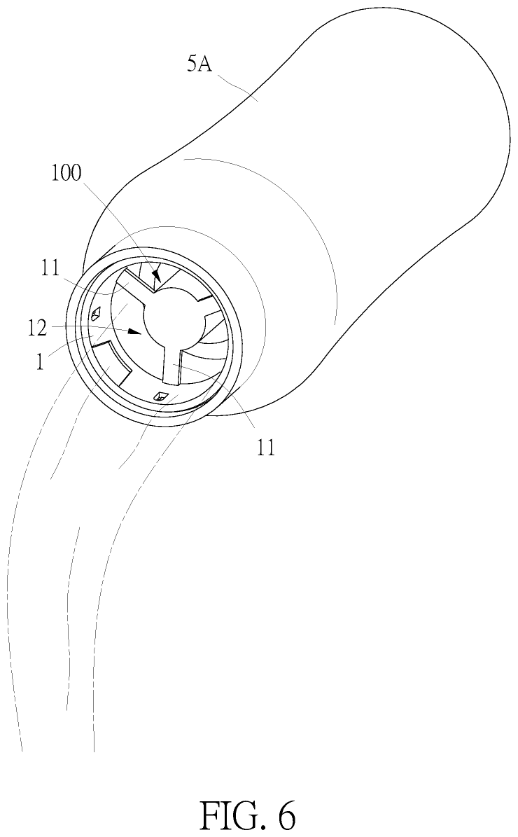

As shown in FIG. 6, it is not necessary to remove the strainer 100 first, and tea can be directly poured out through the outlets 12 located between the bridge portions 11 and the ring member 1 by tilting the body 5A.

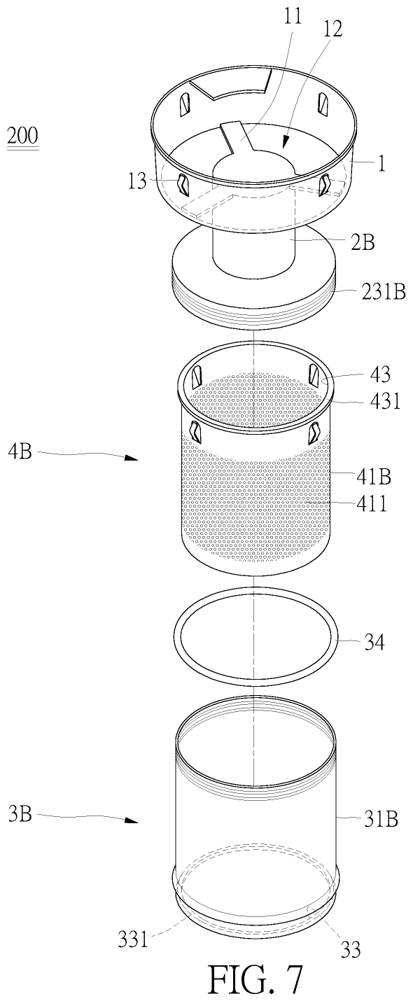

Referring to FIG. 7, the strainer 200 according to a second embodiment of the present invention includes a ring member 1, a connecting member 2B, a first bucket member 3B and a second bucket member 4B. The connecting member 2B has a columnar body with three bridge portions 11 disposed at a top end. Each of the three bridge portions 11 is connected with the ring member 1 and thus three outlets 12 are formed between the bridge portions 11 and the ring member 1. Four positioning portions 13 are provided on a periphery of the ring member 1 for connection with a beverage container. In this embodiment, each of the positioning portions 13 is a flake bent outwardly from the ring member 1.

A bottom end 231B of the connecting member 2B expands and engages with the first bucket member 3B by threads.

The first bucket member 3B has a first annular wall 31B with no sieve hole, and thus an interior and an exterior of the first bucket member 3B are not in communication with each other through the first annular wall 31B directly. The second bucket member 4B has a second annular wall 41B provided with a plurality of side sieve holes 411. The second annular wall 41B is connected with a bottom wall 42B provided with no sieve hole, and thus an interior and an exterior of the second bucket member 4B are not in communication with each other through the second annular wall 41B directly.

A top end of the first annular wall 31B is connected with the bottom end 231B of the connecting member 2B. A bottom end of the first annular wall 31B has a first opening 33 with an inner flange 331. A top end of the second annular wall 41B has a second opening 43 with an outer flange 431.

The second bucket member 4B is provided inside the first bucket member 3B. The second opening 43 is in communication with the first opening 33. The second annular wall 41B is movably connected with the first annular wall 31B so that the second bucket member 4B is capable of moving upwardly or downwardly along the first bucket member 3B. Accordingly, volume of the strainer 200 can be changed.

When pulling down the second bucket member 4B, the outer flange 431 is blocked by the inner flange 331 so as to prevent the second bucket member 4B from leaving the first bucket member 3B. Furthermore, the bottom end of the first annular wall 31B is provided with a waterproof ring 34 closely connected with the second annular wall 41B.

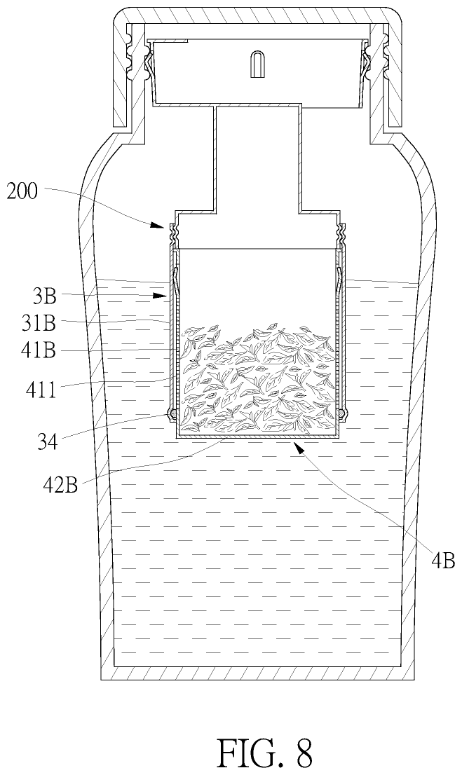

As shown in FIG. 8, when the second bucket member 4B is pushed upwardly into the first bucket member 3B, the waterproof ring 34 seals at a position under the side sieve holes 411 on the second annular wall 41B so that gap between the first annular wall 31B and the second annular wall 41B is sealed. Further with cooperation of the bottom wall 42B provided with no sieve hole, the whole strainer 200 is sealed to prevent water from entering, and hence flavor of the tea stops growing.

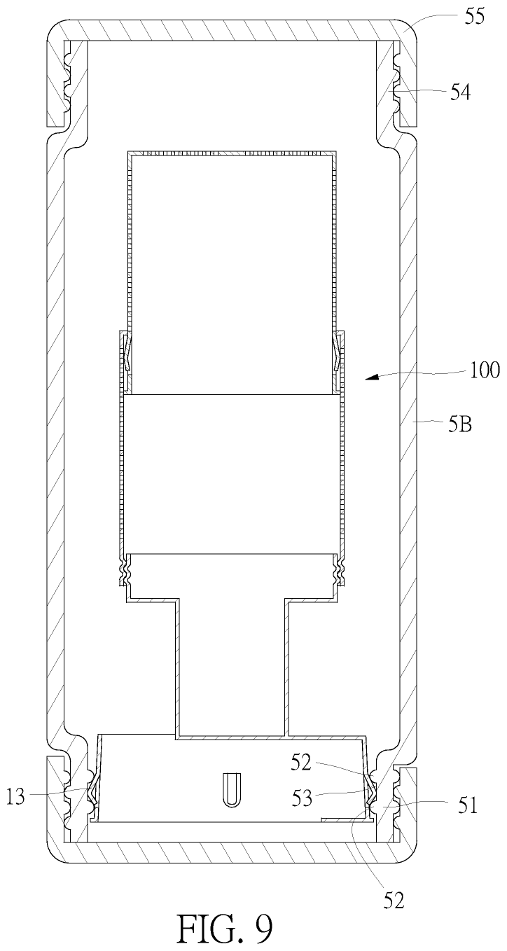

Referring to FIG. 9, the beverage container according to a second embodiment of the present invention includes a body 5B having a first opening end 51 with a coupling portion for connection with the strainer 100. The coupling portion includes two spaced annular flanges 52 with a groove 53 therebetween. The positioning portions 13 of the ring member 1 are inserted into the groove 53 so that the strainer 100 is positioned in the body 5B. A second opening end 54 with a detachable lid 55 is disposed at an end of the body 5B opposite to the first opening end 51. Accordingly, tea can be poured out through the first opening end 51 or the second opening end 54.

What is claimed is:

1. A strainer with changeable volume, characterized by comprising:
a ring member with a positioning portion provided on a periphery of the ring member for connection with a beverage container;
a connecting member with a plurality of bridge portions connected with the ring member, wherein a plurality of outlets is formed between the bridge portions and the ring member;
a first bucket member including a first annular wall connected with a bottom end of the connecting member, wherein a first opening and a first stopping portion are disposed at a bottom end of the first annular wall; and
a second bucket member including a second annular wall connected with a bottom wall, a top end of the second annular wall having a second opening communicated with the first opening and a second stopping portion, the second annular wall having a plurality of side sieve holes, wherein the second annular wall is movably connected with the first annular wall so that the second bucket member is capable of moving upwardly or downwardly along the first bucket member, the second stopping portion is blocked by the first stopping portion to prevent the second bucket member from leaving the first bucket member.

2. The strainer with changeable volume of claim 1, wherein the second bucket member is provided inside the first bucket member, the first stopping portion is an inner flange formed on the first opening while the second stopping portion is an outer flange formed on the second opening.

3. The strainer with changeable volume of claim 2, wherein a top end of the first annular wall detachably connects with the bottom end of the connecting member by threads.

4. The strainer with changeable volume of claim 2, wherein the second annular wall is provided with a slip proof portion abutting against the first annular wall.

5. The strainer with changeable volume of claim 2, wherein the bottom wall of the second bucket member is provided with a plurality of bottom sieve holes.

6. The strainer with changeable volume of claim 2, wherein an interior and an exterior of the first bucket member are not in communication with each other through the first annular wall directly, the bottom end of the first annular wall is provided with a waterproof ring closely connected with the second annular wall.

7. A beverage container having a strainer, characterized by comprising:
a body having a first opening end with a coupling portion; and
the strainer including:
a ring member with a positioning portion provided on a periphery of the ring member for connection with the coupling portion;
a connecting member with a plurality of bridge portions connected with the ring member, wherein a plurality of outlets is formed between the bridge portions and the ring member;
a first bucket member including a first annular wall connected with a bottom end of the connecting member, wherein a first opening and a first stopping portion are disposed at a bottom end of the first annular wall; and
a second bucket member including a second annular wall connected with a bottom wall, a top end of the second annular wall having a second opening communicated with the first opening and a second stopping portion, the second annular wall having a plurality of side sieve holes, wherein the second annular wall is movably connected with the first annular wall so that the second bucket member is capable of moving upwardly or downwardly along the first bucket member, the second stopping portion is blocked by the first stopping portion to prevent the second bucket member from leaving the first bucket member.

8. The beverage container of claim 7, wherein a second opening end with a detachable lid is disposed at an end of the body opposite to the first opening end.
